(19) United States
(12) Patent Application Publication
(10) Pub. No.: US 2015/0066874 A1
(43) Pub. Date: Mar. 5, 2015

(54) DATA DEDUPLICATION IN AN INTERNET SMALL COMPUTER SYSTEM INTERFACE (iSCSI) ATTACHED STORAGE SYSTEM

(71) Applicant: International Business Machines Corporation, Armonk, NY (US)

(72) Inventors: Janmejay S. Kulkarni, Navi Mumbai (IN); Sapan J. Maniyar, Pune (IN); Sarvesh S. Patel, Pune, IN (US); Subhojit Roy, Pune, IN (US)

(73) Assignee: International Business Machines Corporation, Armonk, NY (US)

(21) Appl. No.: 14/022,330

(22) Filed: Sep. 10, 2013

Related U.S. Application Data
(63) Continuation of application No. 14/011,821, filed on Aug. 28, 2013.

(51) Int. Cl. G06F 3/06

(52) U.S. Cl. CPC G06F 3/0641; G06F 3/0608; G06F 3/0671
USPC 707/692

(57) ABSTRACT

Embodiments of the present invention disclose a method, computer program product, and system for data deduplication. Receiving a protocol data unit (PDU) that includes data to be stored on a system and a hash value that corresponds to the data. Determining whether the hash value of the received PDU matches a stored hash value that corresponds to data that is stored in the system. Responsive to determining that the hash value of the received PDU does not match a stored hash value, storing the data included in the received PDU in the system. In another embodiment, the system is an iSCSI attached storage system, and the PDU is an iSCSI PDU.

### CROSS-REFERENCE TO RELATED APPLICATIONS

This application is a continuation of U.S. patent application Ser. No. 14/011,821 filed on Aug. 28, 2013, the entire content and disclosure of which is incorporated herein by reference.

### FIELD OF THE INVENTION

The present disclosure relates generally to the field of data storage systems, and more particularly to data deduplication in an Internet Small Computer System Interface (iSCSI) attached storage system.

### BACKGROUND OF THE INVENTION

Storage system data deduplication techniques attempt to efficiently utilize storage capacity by reducing an amount of duplicate data stored in the storage system. Data deduplication is often called “intelligent compression” or “single-instance storage”. When a data is written to a storage system, the data is partitioned into chunks of data and a hash of each chunk (a signature) is generated, using a hash algorithm such as SHA-256 (secure hash algorithm), which contains fewer bits than the chunk to be stored. The hash is then compared with hashes of previously stored chunks. It is improbable that two chunks of data that are not the same will generate the same hash, called a hash collision, but it is possible with some hash algorithms, and results in a false positive. However, if two hashes are different, the data that generated each hash are without exception different from each other. Therefore, if a match does not occur, a copy of the data is not already stored on the storage system and the data is stored on the system. If a match occurs, a copy of the data being written is almost certainly on the storage system.

An iSCSI attached storage system is a storage system that is accessed via an Internet Small Computer System Interface (iSCSI), which is an Internet Protocol-based storage networking standard for linking computers with data storage facilities. An iSCSI is used to transmit data over local area networks, wide area networks, and the Internet and enables data storage and retrieval from physically dispersed storage systems. The iSCSI protocol inserts an iSCSI packet, called an iSCSI Protocol Data Unit (PDU) into a TCP/IP packet, as a payload. A PDU may include iSCSI control information, data order information, and data. To help ensure the accurate transmission of data over an iSCSI link a PDU can optionally contain a cyclic redundancy check (CRC) checksum on various specified components of the PDU, including data that is being written to or read from storage. The CRC checksum (i.e., hash) can detect most errors in a PDU, but not correct errors, therefore a detected error would require a re-transmission of the PDU. A CRC checksum generated on the data component of a PDU is called a data digest.

### SUMMARY

Embodiments of the present invention disclose a method, computer program product, and system for data deduplication. Receiving a protocol data unit (PDU) that includes data to be stored on a system and a hash value that corresponds to the data. Determining whether the hash value of the received PDU matches a stored hash value that corresponds to data that is stored in the system. Responsive to determining that the hash value of the received PDU does not match a stored hash value, storing the data included in the received PDU in the system. Storing hash value of the received PDU and an associated reference to a storage location on the system at which the data included in the received PDU is stored. In another embodiment, the system is an iSCSI attached storage system, and the PDU is an iSCSI PDU.

In another embodiment, responsive to determining that the hash value of the received PDU does match a stored hash value, identifying a storage location on the system at which the data corresponding to the determined matching hash value utilizing a stored associated reference to the storage location. Storing a reference to the identified storage location, wherein the reference to the identified storage location directs requests to access the data included in the received PDU to the storage location of the data corresponding to the determined matching hash value. In another embodiment, determining whether the data included in the received PDU matches the data corresponding to the determined matching hash value.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for performing a data deduplication check for received iSCSI PDUs, in accordance with an embodiment of the present invention.

FIG. 3 is a flowchart depicting operational steps of a program for performing a data deduplication check for received iSCSI PDUs that include critical data, in accordance with an embodiment of the present invention.

FIG. 4 depicts a block diagram of components of the computing system of FIG. 1 in accordance with an embodiment of the present invention.

### DETAILED DESCRIPTION

Exemplary embodiments of the present invention allow for utilizing an existing data digest included in an Internet Small Computer Interface (iSCSI) Protocol Data Unit (PDU) to perform data deduplication. In one embodiment, a data digest included in a received iSCSI PDU is compared to data digests corresponding to data that is currently stored in an iSCSI attached storage system to determine whether or not a matching data digest exists. In another embodiment, for critical data, responsive to determining that a matching data digest does exist, the data in the received iSCSI PDU is compared to the stored data corresponding to the matching data digest to determine a confirmation of whether or not the data matches.

Embodiments of the present invention recognize that data duplication on a storage system is decreased by a technique involving a generation, recording, and comparison of hashes. However, a generation of a hash from data to be written to a storage system is computation intensive, therefore consuming time and decreasing a throughput of the storage system. Since storage controllers can serve many servers, in-line data deduplication can become a resource intensive process.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

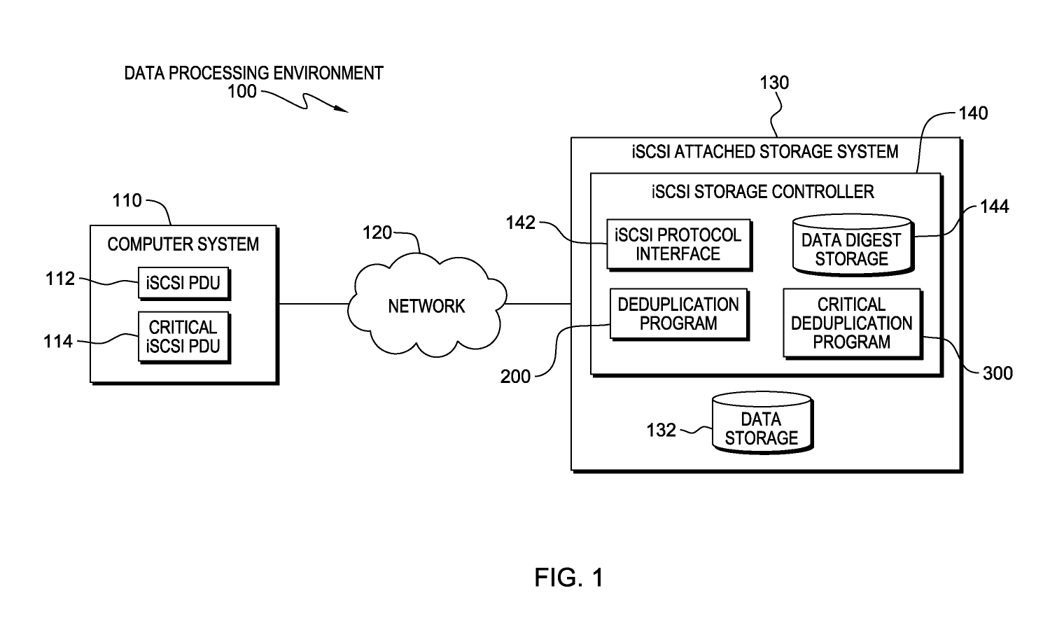

The present invention will now be described in detail with reference to the Figures. FIG. 1 is a functional block diagram illustrating data processing environment 100, in accordance with one embodiment of the present invention.

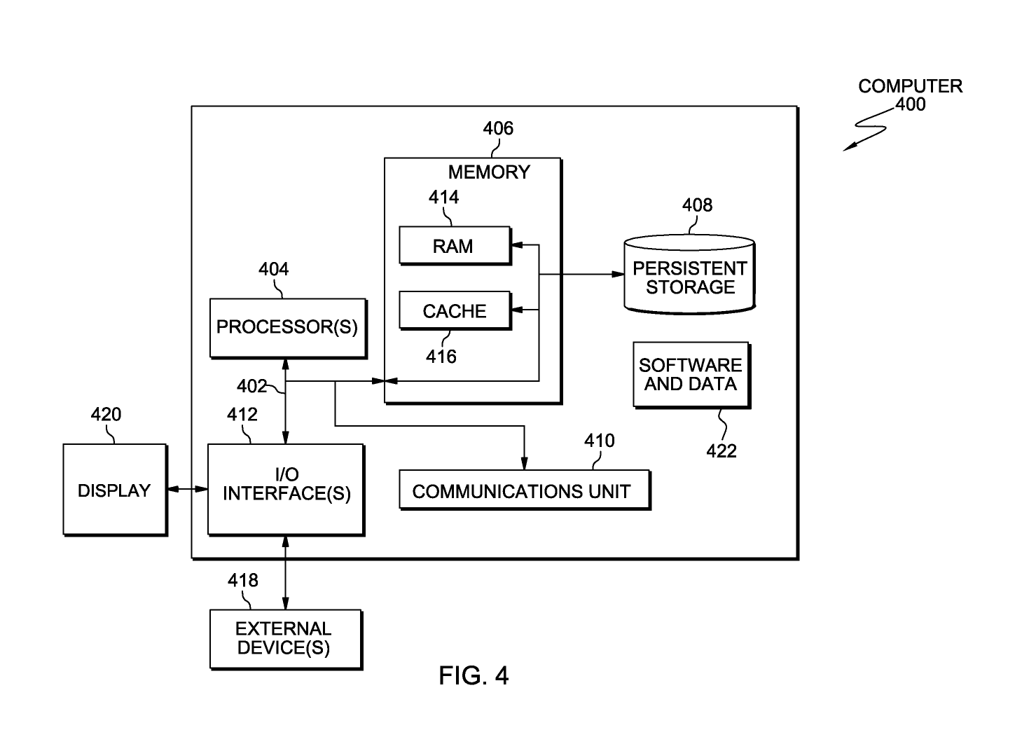

An exemplary embodiment of data processing environment 100 includes computer system 110 and iSCSI attached storage system 130, interconnected over network 120. Computer system 110 can be any form of computing system that can utilize iSCSI attached storage system 130 for storing data, in accordance with embodiments of the present invention. Computer system 110 sends iSCSI PDUs to iSCSI attached storage system 130 for storage, via network 120. In exemplary embodiments, computer system 110 can be a desktop computer, computer server, or any other computer system known in the art, in accordance with embodiments of the invention. In certain embodiments, computer system 110 represents computer systems utilizing clustered computers and components (e.g., database server computers, application server computers, etc.) that act as a single pool of seamless resources when accessed by elements of data processing environment 100 (e.g., iSCSI attached storage system 130). In general, computer system 110 is representative of any electronic device or combination of electronic devices capable of executing machine-readable program instructions, as described in greater detail with regard to FIG. 4, in accordance with embodiments of the present invention.

Computer system 110 includes iSCSI PDU 112 and critical iSCSI PDU 114. An iSCSI PDU may include iSCSI control information, data order information, a data digest, and data. The data digest is cyclic redundancy check (CRC) checksum (i.e., hash value) on various specified components of the PDU, including the data included in the PDU (e.g., a chunk of data in an iSCSI PDU to be stored on iSCSI attached storage system 130). The data included in an iSCSI PDU (i.e., iSCSI PDU 112 and critical iSCSI PDU 114) can be chunks of data, which is included as the data payload of the iSCSI PDU. In one embodiment, critical iSCSI PDU 114 includes data that computer system 110 has designated to be critical (e.g., banking records, medical data, operating system code, etc.). In another embodiment, iSCSI PDU 112 includes data that computer device 110 has not designated to be critical (e.g., photos, videos, etc.).

In one embodiment, computer system 110 and iSCSI attached storage system 130 communicate through network 120. Network 120 can be, for example, a local area network (LAN), a telecommunications network, a wide area network (WAN) such as the Internet, or a combination of the three, and include wired, wireless, or fiber optic connections. In general, network 120 can be any combination of connections and protocols that will support communications between computer system 110 and iSCSI attached storage system 130 in accordance with embodiments of the present invention.

In one embodiment, iSCSI attached storage system 130 is a storage system that is accessed via the iSCSI protocol. In exemplary embodiments, iSCSI attached storage system 130 can be any form of system that is capable of storing data. iSCSI attached storage system 130 receives and processes iSCSI PDUs (e.g., iSCSI PDU 112 and critical iSCSI PDU 114) from computer system 110, via network 120. In another embodiment, iSCSI PDU 112 and critical iSCSI PDU 114 can be any form of PDUs that include data to be stored on an attached storage system. In exemplary embodiments, iSCSI attached storage system 130 can be a desktop computer, computer server, or any other computer system known in the art, in accordance with embodiments of the invention. In certain embodiments, iSCSI attached storage system 130 represents computer systems utilizing clustered computers and components (e.g., database server computers, application server computers, etc.) that act as a single pool of seamless resources when accessed by elements of data processing environment 100 (e.g., computer system 110). In general, iSCSI attached storage system 130 is representative of any electronic device or combination of electronic devices capable of executing machine-readable program instructions, as described in greater detail with regard to FIG. 4, in accordance with embodiments of the present invention.

iSCSI attached storage system 130 includes data storage 132 and iSCSI storage controller 140. Data storage 132 stores data from iSCSI PDUs (e.g., iSCSI PDU 112 and critical iSCSI PDU 114), which iSCSI attached storage system 130 receives from computer system 110. Data storage 132 can be implemented with any type of storage device that is capable of storing data that may be accessed and utilized by computer device 110 and iSCSI attached storage system 130 such as a database server, a hard disk drive, or flash memory. In other embodiments, data storage 132 can represent multiple storage devices within iSCSI attached storage system 130.

In one embodiment, iSCSI storage controller 140 receives iSCSI PDUs (e.g., iSCSI PDU 112 and critical iSCSI PDU 114) that are sent to iSCSI attached storage system 130, and performs data deduplication processes in accordance with embodiments of the present invention. iSCSI storage controller 140 includes iSCSI protocol interface 142, data digest storage 144, deduplication program 200, and critical deduplication program 300. iSCSI protocol interface 142 processes received iSCSI PDUs so that iSCSI storage controller 140 can utilize data included in the iSCSI PDUs (e.g., iSCSI control information, data order information, data digest, and data). Data digest storage 144 stores data digests of iSCSI PDUs and a reference to the storage location of respective data from iSCSI PDUs. Data digest storage 144 can be implemented with any type of storage device that is capable of storing data that may be accessed and utilized by iSCSI attached storage system 130 such as a database server, a hard disk drive, or flash memory. In other embodiments, data digest storage 144 can represent multiple storage devices within iSCSI storage controller 140. In another embodiment, data storage 132 and data digest storage 144 can exist as the same storage device, which may be included in iSCSI attached storage system 130 or iSCSI storage controller 140.

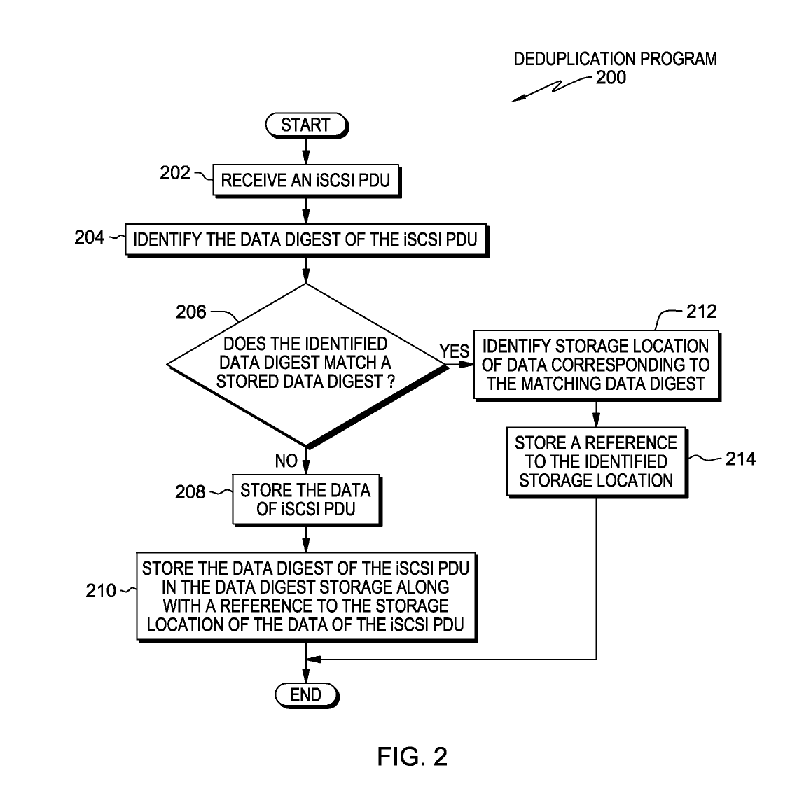

In exemplary embodiments, deduplication program 200, which is discussed in greater detail with regard to FIG. 2, performs a data deduplication check for received iSCSI PDUs (i.e., iSCSI PDU 112). In exemplary embodiments, critical deduplication program 300, which is discussed in greater detail with regard to FIG. 2, performs a data deduplication check for received iSCSI PDUs that include critical data (i.e., critical iSCSI PDU 114). Deduplication program 200 and critical deduplication program 300 are methods that iSCSI attached storage system 130 can utilize corresponding to whether or not an iSCSI PDU (e.g., iSCSI PDU 112 and critical iSCSI PDU 114) includes critical data. For example, iSCSI attached storage system 130 can be intended to be used as a storage system for non-critical data, or for critical data. If iSCSI attached storage system 130 is intended to be used for non-critical data, then deduplication program 200 processes iSCSI PDUs. If iSCSI attached storage system 130 is intended to be used for critical data, then critical deduplication program 300 processes iSCSI PDUs. In exemplary embodiments, iSCSI attached storage system 130 can utilize deduplication program 200 or critical deduplication program 300 responsive to configuration by a storage administrator (or other individuals associated with iSCSI attached storage system 130), or by indications in the received iSCSI PDUs or other associated iSCSI packets as to whether the data is critical or non-critical.

FIG. 2 is a flowchart depicting operational steps of deduplication program 200 in accordance with an exemplary embodiment of the present invention. In one embodiment, deduplication program 200 initiates responsive to iSCSI attached storage system 130 receiving an iSCSI PDU that does not contain critical data (i.e., iSCSI PDU 112). In exemplary embodiments, deduplication program 200 processes iSCSI PDUs when iSCSI attached storage system 130 is utilized for storage of non-critical data (e.g., video and image storage, etc.).

In step 202, deduplication program 200 receives an iSCSI PDU. In one embodiment, iSCSI attached storage system 130 receives iSCSI PDU 112 from computer system 110. Since iSCSI PDU 112 does not include critical data, deduplication program 200 performs data deduplication for iSCSI PDU 112 on iSCSI attached storage system 130.

In step 204, deduplication program 200 identifies the data digest of the iSCSI PDU. In one embodiment, upon receiving iSCSI PDU 112 from computer system 110, deduplication program 200 utilizes iSCSI protocol interface 142 on iSCSI storage controller 140 to identify data included in iSCSI PDU 112. The identified data includes iSCSI control information, data order information, data digest, and data.

In decision step 206, deduplication program 200 determines whether the identified data digest matches a stored data digest. In one embodiment, deduplication program 200 compares the identified data digest of iSCSI PDU 112 (from step 204) to data digests that are stored in data digest storage 144. The stored data digests of data digest storage 144 correspond to data from iSCSI PDUs, which is stored in data storage 132. In exemplary embodiments, when data from an iSCSI PDU is stored in data storage 132, the corresponding data digest of the iSCSI PDU is stored in data digest storage 144, along with a reference to the storage location of the corresponding data on data storage 132.

In step 208, deduplication program 200 stores the data of the iSCSI PDU. In one embodiment, responsive to determining that the identified data digest of iSCSI PDU 112 (from step 204) does not match a stored data digest from data digest storage 144, deduplication program 200 stores the data of iSCSI PDU 112 in data storage 132. In exemplary embodiments, since data digest storage 144 does not include a matching data digest, deduplication program 200 determines that the data in iSCSI PDU 112 (i.e. chunk of data included in payload of iSCSI PDU 112) does not already exist in data storage 132.

In step 210, deduplication program 200 stores the data digest of the iSCSI PDU in the data digest database along with a reference to the storage location of the data of the iSCSI PDU. In one embodiment, deduplication program 200 stores the data digest of iSCSI PDU 112 in data digest storage 144, which indicates that data corresponding to that data digest is stored in data storage 132. In another embodiment, deduplication program 200 stores a reference to the storage location (from step 208 on data storage 132) of the data of iSCSI PDU 112. The stored reference indicates the specific on-disk location within data storage 132 that corresponds to where the data of iSCSI PDU 112 is stored. In an example, deduplication program 200 stores the data digest of iSCSI PDU 112 on data digest storage 144, and includes an associated reference to the storage location (e.g., on-disk storage location) of the data in iSCSI PDU 112 (i.e. chunk of data included in payload of iSCSI PDU 112) that was stored in step 208.

In step 212, deduplication program 200 identifies the storage location of data corresponding to the matching data digest. In one embodiment, responsive to determining that the identified data digest of iSCSI PDU 112 (from step 204) does match a stored data digest from data digest storage 144, deduplication program 200 identifies the storage location of data corresponding to the matching data digest. Data digests stored on data digest storage 144 include an associated reference to the storage location (e.g., on-disk storage location) of corresponding data. Deduplication program 200 identifies the storage location that corresponds to the determined matching data digest (decision step 206) by utilizing the associated reference to the storage location that is stored in data digest storage 144.

In step 214, deduplication program 200 stores a reference to the identified storage location. In one embodiment, since deduplication program 200 determined (in decision step 206) that data digest storage 144 includes a data digest that matches the data digest of iSCSI PDU 112, the data included in iSCSI PDU 112 does not need to be stored in data storage 132. Instead, deduplication program 200 stores a reference to the storage location (identified in step 212) of data corresponding to the matching data digest on data storage 132. The stored reference is a storage location address of the data corresponding to the matching data digest, which is already stored on data storage 132.

In an example, in decision step 206 deduplication programs 200 determines that the data digest of iSCSI PDU 112 matches a data digest stored in data digest storage 144. Deduplication program 200 does not store the data from iSCSI PDU 112 in data storage 132, and instead stores a reference to the storage location (identified in step 212) of the data corresponding to the matching data digest. When iSCSI attached storage system 130 receives a request to access the data that was included in iSCSI PDU 112 from computer system 110, the stored reference in data storage 132 directs computer system 110 to storage location on data storage 132 of the data corresponding to the matching data digest, and accesses the data corresponding to the matching data digest.

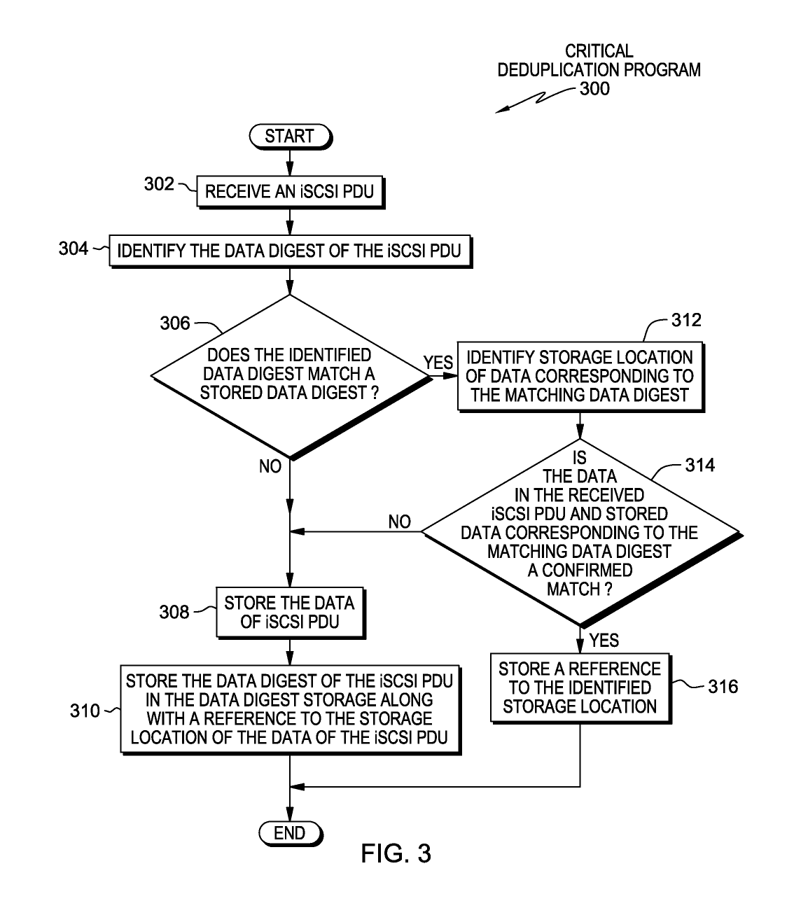

FIG. 3 is a flowchart depicting operational steps of critical deduplication program 300 in accordance with an exemplary embodiment of the present invention. In one embodiment, deduplication program 200 initiates responsive to iSCSI attached storage system 130 receiving an iSCSI PDU that contains critical data (i.e., critical iSCSI PDU 114). For example, computer system 110 sends critical iSCSI PDU 114 to iSCSI attached storage system 130 for storage, and indicates that critical iSCSI PDU 114 includes critical data. In exemplary embodiments, critical deduplication program 300 processes iSCSI PDUs when iSCSI attached storage system 130 is utilized for storage of critical data (e.g., financial record storage, medical data storage, etc.).

Steps 302 through 312 of critical deduplication program 300 operate similarly to embodiments described above in FIG. 2 with regard to respective steps 202 through 212 of deduplication program 200. In an example, critical deduplication program 300 determines whether the identified data digest of critical iSCSI PDU 114 (from step 304) matches a stored data digest stored in data digest database 144. Responsive to determining that the identified data digest of critical iSCSI PDU 114 does match a stored data digest from data digest storage 144, critical deduplication program 300 identifies the storage location of data corresponding to the matching data digest (step 312).

In decision step 314, critical deduplication program 300 determines whether the data in the received iSCSI PDU and stored data corresponding to the matching data digest are a confirmed match. In one embodiment, critical deduplication program 300 utilizes the identified storage location (on data storage 132) of data corresponding to the matching data digest (identified in step 312) to determine whether the data included in critical iSCSI PDU 114 is the same as the data corresponding to the matching data digest. In an exemplary embodiment, critical deduplication program 300 performs a bit level comparison to determine whether the data in critical iSCSI PDU 114 is an exact match to the data in the identified storage location. Since a possibility exists that two different chunks of data can have identical corresponding data digests (i.e. hash collision), critical deduplication program 300 confirms whether or not data with matching corresponding data digests are exact matches. Responsive to determining that the data in the received iSCSI PDU and stored data corresponding to the matching data digest are not a confirmed match, critical deduplication program 300 stores the data of the iSCSI PDU in data storage 132 (step 308).

In step 316, critical deduplication program 300 stores a reference to the identified storage location. In one embodiment, responsive to determining that the data in critical iSCSI PDU 114 and stored data corresponding to the matching data digest are a confirmed match, critical deduplication program 300 stores a reference to the storage location (identified in step 212) of data corresponding to the matching data digest on data storage 132. In an exemplary embodiment, critical deduplication program 300 confirms that the data in critical iSCSI PDU 114 and stored data corresponding to the matching data digest match (e.g., through a bit level comparison) are an exact match, and therefore a reference to the identified storage location (of step 312) can be stored on data storage 132. Step 316 is similar to embodiments described in greater detail with regard to step 214 of deduplication program 200.

FIG. 4 depicts a block diagram of components computer 400, which is representative of computer system 110 and iSCSI attached storage system 130 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media. Software and data 422 are stored in persistent storage 408 for access and/or execution by processors 404 via one or more memories of memory 406. With respect to computer device 110, software and data 422 represents iSCSI PDU 112 and critical iSCSI PDU 114. With respect to iSCSI attached storage system 130, software and data 422 includes deduplication program 200 and critical deduplication program 300.

In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Software and data 422 may be downloaded to persistent storage 408 through communications unit 410.

I/O interface(s) 412 allows for input and output of data with other devices that may be connected to computer 400. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data 422 can be stored on such portable computer-readable storage media and can be loaded onto persistent storage 408 via I/O interface(s) 412. I/O interface(s) 412 also can connect to a display 420.

Display 420 provides a mechanism to display data to a user and may be, for example, a computer monitor. Display 420 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for data deduplication, the method comprising:
receiving a protocol data unit (PDU) that includes data to be stored on a system and a hash value that corresponds to the data;
determining whether the hash value of the received PDU matches a stored hash value that corresponds to data stored in the system; and
responsive to determining that the hash value of the received PDU does not match a stored hash value, storing the data included in the received PDU in the system.

2. The method of claim 1, further comprising:
storing the hash value of the received PDU and an associated reference to a storage location on the system at which the data included in the received PDU is stored;
wherein the system is an iSCSI attached storage system, and the received PDU is an iSCSI PDU.

3. The method of claim 1, further comprising:
responsive to determining that the hash value of the received PDU does match a stored hash value, identifying a storage location on the system of the data corresponding to the matching hash value; and
storing a reference to the identified storage location, wherein the reference to the identified storage location directs requests to access the data included in the received PDU to the storage location of the data corresponding to the determined matching hash value.

4. The method of claim 1, further comprising:
responsive to determining that the hash value of the received PDU does match a stored hash value, identifying a storage location on the system that corresponds to the data corresponding to the determining matching hash value;
determining whether the data included in the received PDU matches the data corresponding to the determined matching hash value; and
responsive to determining that the data included in the received PDU matches the data corresponding to the determined matching hash value, storing a reference to the identified storage location, wherein the reference to the identified storage location directs requests to access the data included in the received PDU to the storage location of the data corresponding to the determined matching hash value.

5. The method of claim 4, wherein the determining whether the data included in the received PDU matches the data corresponding to the determined matching hash value, comprises:
performing a bit level comparison between the data included in the received PDU and the data corresponding to the determined matching hash value.

6. The method of claim 4, further comprising:
responsive to determining that the data included in the received PDU does not match the data corresponding to the determined matching hash value, storing the data included in the received PDU in the system.

7. The method of claim 1, wherein the stored hash values in the system correspond to data included in previously received PDUs.
